(19) United States
(12) Patent Application Publication
(10) Pub. No.: US 2006/0252591 A1
(43) Pub. Date: Nov. 9, 2006

(54) Belt conveyor with external drive

(75) Inventors: Antoine J. H. Winkelmolen, Shawnee, KS (US); Robert G. Jones, Dartmouth (CA); Robin B. McGinley, Hammonds Plains (CA); Oliver Hahn, Parkville, MO (US)

Correspondence Address: SPENCER, FANE, BRITT & BROWNE, 1000 WALNUT STREET, SUITE 1400, KANSAS CITY, MO, 64106-2140, US

(73) Assignee: Johnson Food Equipment, Inc.

(21) Appl. No.: 11/121,239

(22) Filed: May 3, 2005

(51) Int. Cl. F16H 7/00

(52) U.S. Cl. 474/153

(57) ABSTRACT

A belt conveyor system (10) having a continuous, looping carrier belt (28) entrained around a belt plate (20) which is supported by a frame (12). The belt plate (20) is secured to the frame (12) by securement pins (26a) and pivot pins (26b). The carrier belt (28) is driven externally rather than internally and is tensioned with minimal obstruction to removing the belt (28), which thereby facilitates disassembly of the system (10), particularly frequent removal, cleaning, and replacement of the belt (28) as may be necessary or desirable in, for example, the food processing industry. More specifically, the drive mechanism (14) is located substantially completely outside of and adjacent to the internal area (41) defined by the looping belt (28), and the tensioning mechanism (22) is low profile presenting minimal to no obstruction when removing the belt (28) from the belt plate (20).

### BACKGROUND OF THE INVENTION

1. Field of the Invention

The present invention relates to belt conveyor systems. More particularly, the present invention concerns belt conveyor systems having external drives which are tensioned with minimal obstruction to removing the belt simplifying disassembly of the systems for cleaning and replacement of the belts as may be necessary or desirable in, for example, the food processing industry.

2. Description of the Prior Art

Processing facilities, for example, sometimes use belt conveyors to transport products from one location to another. Prior art belt conveyors generally comprise four major components: a frame; a belt; a drive mechanism for driving the belt; and a tensioning mechanism for maintaining proper tension on the belt, with the drive and tensioning mechanisms being located within or inside the area defined by the looping belt. Generally, it is desirable to clean belt conveyors regularly in order to prevent the accumulation of dirt and debris. The accumulation of dirt and bacteria is a particular problem in food processing facilities, and, consequently, it is necessary or desirable to clean belt conveyors used in such facilities at least once during each work shift or work day.

A variety of prior art techniques exist for cleaning belt conveyors. In-line cleaning systems, for example, comprise a plurality of spray nozzles or a water bath through which the belt travels and which function to keep the belt reasonably clean during operation. Nevertheless, it is still necessary to regularly clean the belt more thoroughly than is possible with such nozzles or baths. Thoroughly cleaning the belt requires that it be physically disassociated from the system, but because the drive mechanism and tensioning mechanism are located inside the looping belt and supported at both ends by the frame, such disassociation requires at least partially disassembling and subsequently reassembling these major components of the belt conveyor system. It will be appreciated that this is a labor-intensive and time-consuming activity, the inconvenience of which is further exacerbated by the frequency with which it must be performed.

### SUMMARY OF THE INVENTION

The present invention overcomes the above-described and other problems and disadvantages in the prior art by providing a belt conveyor system having a continuous, looping belt which is driven externally rather than internally and which is tensioned with minimal obstruction to removing the belt, which thereby facilitates disassembly of the system, particularly frequent removal, cleaning, and replacement of the belt as may be necessary or desirable in, for example, the food processing industry. More specifically, the drive and tensioning mechanisms are located substantially outside of and adjacent to the internal area defined by the looping belt.

Broadly, the preferred system comprises a frame; the aforementioned drive mechanism including a drive motor and sprockets; a belt plate including the aforementioned integrated tensioning mechanism or “tensioner”; supporting posts; retaining pins; and the aforementioned looping belt. The frame supports the remaining components in their relative operating positions and conditions. The frame has first and second sides and two elongated, parallel openings extending there between. The drive motor and sprockets drive the belt, and are mounted to or near the first side of the frame such that upper portions of the sprockets protrude through respective openings to the second side of the frame.

The belt plate supports the belt, and the integrated tensioner allows for properly tensioning the belt upon the belt plate. The supporting posts project substantially perpendicularly outward from the second side of the frame, and support the belt plate and integrated tensioner in a spaced relation with the second side of the frame. The height of the posts are fixed or adjustable such that the belt, being entrained about the belt plate and integrated tensioner, engages the upper portions of the sprockets protruding through the openings in the frame.

The retaining pins removably couple the belt plate with the posts. A first pair of the pins each pass substantially perpendicularly through the belt plate into respective first posts. A second pair of the pins are each pressed into opposite sides of the belt plate so as to project perpendicularly outward from the sides, and are slidably received into recesses in respective second posts. The belt is a continuous, looping belt of material onto which items may be placed such that the items are carried by the motion of the belt from one location to another. The belt is entrained about and travels around the belt plate and integrated tensioner, and engages the upper portions of the sprockets such that the rotational motion of the driven sprockets is translated into the looping motion of the belt.

It will be understood and appreciated that when it is desired to clean the belt, the first pair of pins are removed from the first posts; and the belt plate is moved in such a manner as to disengage the second pair of pins from the second posts, thereby allowing the belt plate to be quickly and easily disassociated from the frame, drive mechanism, and tensioner. The belt can then be quickly and easily removed from the belt plate and cleaned as desired. Reassembly is accomplished by reversing the preceding steps.

Thus, it will be understood and appreciated that the present invention provides a number of advantages over the prior art, including, for example, facilitating the quick and easy removal and replacement of the belt for cleaning. It will be appreciated that this is particularly advantageous for situations in which it is necessary to clean the belt frequently, such as, for example, in food processing facilities.

These and other features of the present invention are discussed in greater detail below.

### BRIEF DESCRIPTION OF THE DRAWINGS

An embodiment of the present invention is described in detail below with reference to the attached drawing figures, wherein:

FIG. 1 is an exploded isometric view of an embodiment of the belt conveyor system of the present invention;

FIG. 2 is a side elevation view of the belt conveyor system of FIG. 1; and

FIG. 3 is an isometric view of the belt conveyor system of FIG. 1.

### DETAILED DESCRIPTION

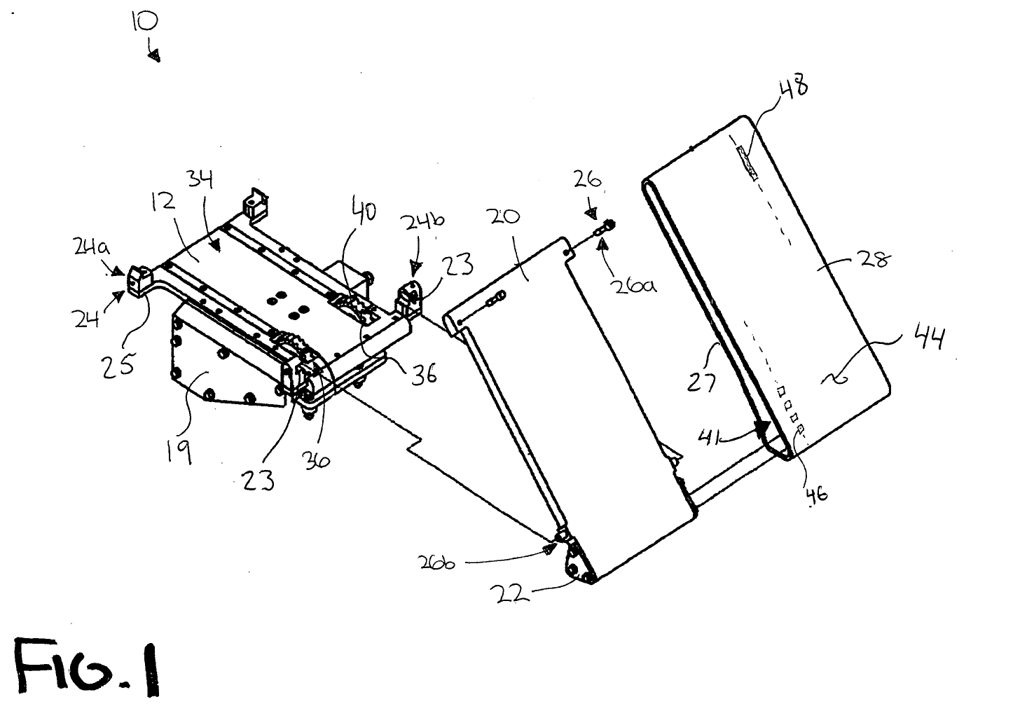

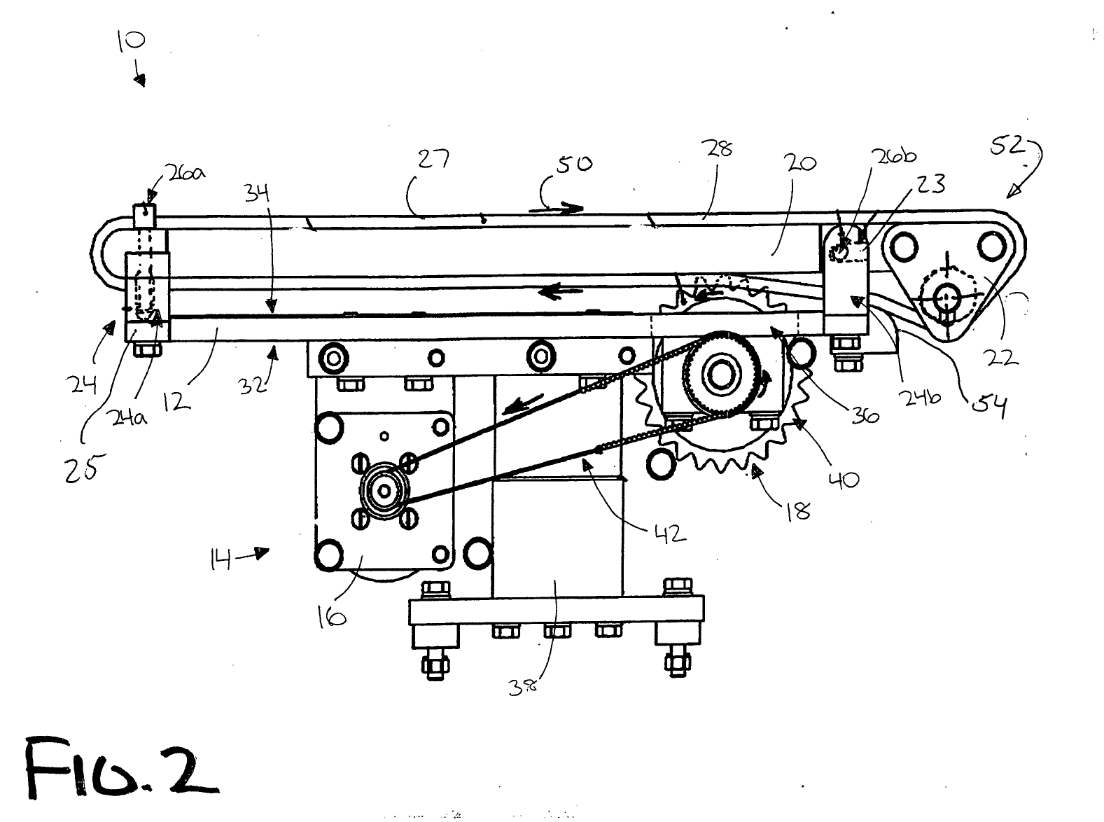

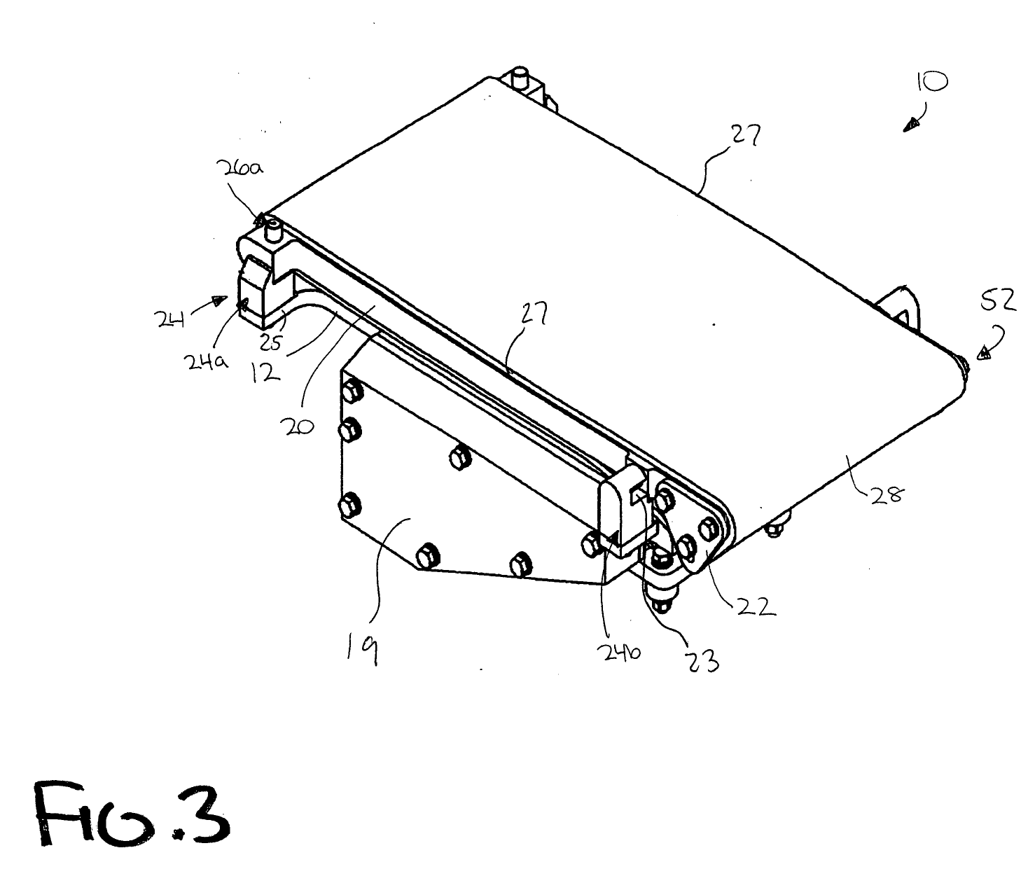

With reference to FIGS. 1, 2, and 3, a belt conveyor system 10 is described, shown, and otherwise disclosed in accordance with the preferred embodiment(s) of the present invention. Broadly, the system 10 has a continuous, looping belt which is driven externally rather than internally and which is tensioned with minimal obstruction to removing the belt, which thereby facilitates disassembly of the system, particularly frequent removal, cleaning, and replacement of the belt as is necessary or desirable in, for example, the food processing industry. More specifically, drive and tensioning mechanisms are located substantially outside of and adjacent to the internal area defined by the looping belt.

Broadly, in a preferred but non-limiting embodiment, the system 10 comprises a frame 12; the drive mechanism 14 including a drive motor 16 and sprockets 18; a belt plate 20 including the integrated tensioning mechanism or “tensioner” 22; supporting posts 24; retaining pins 26; and the carrier belt 28. As a general matter, each of these components may be constructed in any suitable manner and from any suitable material or combination of materials. Furthermore, the design and construction of each of these components and of the system generally may vary considerably depending on the particular application for which the system is intended and corresponding factors and considerations such as, for example, size, capacity, performance, and other physical and functional characteristics.

The frame 12 substantially physically and mechanically supports some or all of the remaining components in their relative operating positions and conditions. The frame 12 is substantially rectangular in shape and presents first and second sides 32, 34 and two elongated, parallel openings 36 extending there between through which the drive sprockets 18 protrude, as discussed below. If desired, the openings 36 may open to the edges, so that they are recesses into the edge of the frame. The frame 12 may include additional structure as necessary or desired, such as, for example, a fixed or adjustable base or pedestal 38 for positioning the belt 28 at its proper or desired operating height. The frame 12 may be constructed of any suitable materials, for example, metals including steel, stainless steel, or aluminum, non-metals such as reinforced plastic or fiberglass, or any combination thereof.

The exterior drive mechanism 14 is mounted substantially outside of the belt and drives the belt 28. The drive motor 16 is substantially any suitable motor or engine for converting electrical or chemical or other forms of energy into motion, preferably rotational motion, and is mounted inside a protective housing 19. Each drive member, in the embodiment illustrated a sprocket 18, is substantially circular and presents a plurality of teeth 40 projecting radially outward from its circumferential periphery. In alternate embodiments, the drive member of the drive mechanism is a drive belt or other device for engaging the carrier belt. The drive motor 16 is mounted, such as with screws or bolts, to or near the first lower side 32 of the frame 12. The sprockets 18 are coupled directly with the motor 16, or, alternatively, are rotatably coupled, such as with screws or bolts, to or near the first side 32 of the frame 12. In this latter implementation, a transmission mechanism 42, such as a belt or chain, may be used to transfer the driving motion of the motor 16 to the sprockets 18. In any event, the sprockets 18 are positioned such that at least some of the teeth 40 or a portion of the sprockets 18 protrude through respective openings 36 to the second side 34 of the frame 12. The sprockets are symmetrically spaced from the longitudinal center lines of the belt and frame, so that they engage the belt adjacent to the edges 27 of the belt and are spaced an equal distance from the edges. Generally, the sprockets are spaced sufficiently that product is carried between the drive openings/recesses 46 or drive strips 48 on the belt, so that product is not damaged by or lodged in the openings 46 or on the strips 48. In alternate embodiments, different numbers of sprockets are used, for example a single centrally located sprocket, three sprockets with two near the edges and one positioned centrally.

The belt plate 20 substantially physically supports the belt 28, and the integrated tensioner 22 allows for properly tensioning (i.e., tightening or loosening) the belt 28 upon the belt plate 20. More specifically, the belt 28 is slidably or otherwise movably entrained about the belt plate 20 and tensioner 22. The tensioner is sized to permit the belt to slide laterally off the belt plate with minimal to no obstruction. The belt plate 20 is preferably substantially rectangular in shape and substantially smooth to reduce friction between it and the belt 28 moving over and about it. The tensioner 22 is provided at one end of the belt plate 20. The tensioner 22 forms a generally triangular shape in the belt causing the belt to extend downwardly to a point, in one embodiment, below the upper side 34, so that the belt must rise to engage the sprockets 18. In another embodiment, the tensioner displaces the belt to a level below the sprocket. This rise enhances engagement between the sprocket and belt. In one embodiment, the belt 28 also contacts a rounded belt guide 54 of the frame. The belt guide 54 controls or limits to a maximum angle at which the belt moves to contact the sprocket. In one embodiment, the belt 28 moves to contact the sprocket at an angle between approximately 0° and approximately 20°, and in another embodiment at an angle between approximately 1° to 10°. In still another embodiment, the angle is approximately 3°, which is the maximum angle allowed by the belt guide 54. The belt plate 20 may be constructed of any suitable materials, for example, metals such as steel, stainless steel, or aluminum, non-metals such as reinforced plastic or fiberglass, or any combination thereof. The tensioner 22 may make use of any suitable tensioning technology, such as, mechanical, hydraulic, or pneumatic expansion and contraction technologies.

The supporting posts 24 project substantially perpendicularly outward from approximately the four corners of the second upper side 34 of the frame 12, and substantially physically support the belt plate 20 and integrated tensioner 22 in a spaced relation with the second side 34 of the frame 12. Furthermore, the height of the posts 24 is such that the belt 28, being entrained about the belt plate 20 and integrated tensioner 22, engages the teeth 40 or portions of the sprockets 18 protruding through the openings 36 in the frame 12. The posts 24 may be adjustable in height in order to achieve the most proper or desired positioning of the belt plate 20.

The retaining pins 26 couple the belt plate 20 with the posts 24. A first pair of the retaining pins 26a each pass substantially perpendicularly through the belt plate 20 and are threadably received into respective first posts 24a, which are positioned on frame tabs 25 extending outwardly from the frame beyond the edges 27 of the belt 28. A second pair of the retaining pins 26b are each pressed into opposite sides of the belt plate 20 so as to project perpendicularly outward therefrom, and are slidably and pivotably receivable into recesses 23 in respective second posts 24b. Thus, after removing the first pair of retaining pins 24a from the first posts 24a, the belt plate 20 can be moved in a particular manner and direction so as to disengage the second pair of retaining pins 24b from the second posts 24b and thereby disassociate the belt plate 20, the integrated tensioner 22, and the belt 28 entrained thereabout from the frame 12. With the pivoting removal assembly provided by the pins and the posts 24, 26, the belt and sprockets are selectively engaged.

The belt 28 is a continuous, looping belt of material onto which items may be placed such that the items are carried by the motion of the belt 28 from one location to another. The belt 28 is entrained about and travels around the belt plate 20 and integrated tensioner 22. In one embodiment, the belt 28 includes spaced openings for engaging the sprocket teeth or otherwise cooperating with the upper portions of the sprockets 18, and by which the rotational motion of the sprockets 18 are translated into the substantially looping motion of the belt 28. In another embodiment, the belt outer surface 44 has recesses 46 to receive the sprocket teeth. Thus, the openings and recesses operate as tooth receivers. Alternatively, the belt may comprise links which form tooth receiving recesses as an inherent feature of the construction. In another embodiment, the belt provides a friction engagement strip 48, and the sprocket has a complementary frictional engagement surface instead of teeth, around its periphery though it may still have some raised contour. Thus, the drive sprocket is located substantially, and in one embodiment entirely outside of an internal area defined by the belt. The belt 28 is constructed from substantially any suitably flexible material(s) or independently movable components.

In exemplary but non-limiting use and operation, the system 10 may function as follows. In ordinary use, the drive motor 16 turns the sprockets 18; the teeth 40 or portions of the driven sprockets 19 project through the openings 36 in the frame 12 and engage the belt 28 to cause looping movement thereof preferably in the direction of arrow 50, so that the lower region of the belt is drawn rearward toward the motor while the upper region of the belt is pulled toward the pivot end 52 of the conveyor; and items placed upon the belt 28 are thereby moved from one location to another. When it is desired to clean or change the belt 28, or to partially disassemble the system 10 for some other reason, the drive motor 16 is shut off or stopped preferably by disconnecting power cords; the first pair of pins 26a are threadably removed from the first posts 24a; and the belt plate 20 is pivoted, around pivot pins 26b, away from the drive mechanism and slid, in such a manner and direction as to disengage the second pair of pins 26b from the recess or pivot slot 23, which is formed in the second posts 24b, thereby allowing the belt plate 20, integrated tensioner 22, and the belt 28 entrained thereabout to be quickly and easily disassociated from the frame 12 and other components of the system 10. With the tensioner loosened, the belt 28 can then be quickly and easily slide from the belt plate 20 and integrated tensioner 22 and cleaned as desired. The cleaned belt 28 is reinstalled and the system 10 made ready for use by reversing the preceeding steps. If desired, the belt plate 20 is just pivoted on pivot pins 26b, so that the plate and belt are at an angle relative to the frame 12 as illustrated in exploded view of FIG. 1. This is useful to remove debris from between the frame 12 and belt 28. The belt plate is then pivoted back to a position substantially parallel to the frame, and the other ended securement pins 26a secure the plate to the frame.

From the preceeding discussion it will be understood and appreciated that the present invention provides a number of advantages over the prior art, including, for example, facilitating the quick and efficient removal and replacement of the belt for cleaning. It will be appreciated that this is particularly advantageous for situations in which it is necessary to clean the belt frequently, such as, for example, in food processing facilities.

Although the invention has been described with reference to the preferred embodiments illustrated in the drawings, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A belt conveyor system comprising:
a drive mechanism; and
a carrier belt movably supported and selectively engaging the drive mechanism, wherein the drive mechanism is located substantially outside of an internal area defined by the carrier belt.

2. The belt conveyor system as set forth in claim 1 further including a frame having a first side and a second side and an opening extending there between, wherein the drive mechanism is substantially located on the first side of the frame and the carrier belt is located on the second side of the frame and a portion of the drive mechanism projects through the opening to engage the carrier belt.

3. The belt conveyor system as set forth in claim 2 further including a belt plate about which the carrier belt is movably entrained.

4. The belt conveyor system as set forth in claim 1 wherein the drive mechanism includes a drive member, and the drive member engages the carrier belt.

5. The belt conveyor system as set forth in claim 4 wherein the drive member is a sprocket which includes a plurality of tooth, and the outer surface of the belt defines a plurality of teeth receivers.

6. The belt conveyor system as set forth in claim 1 wherein the drive mechanism includes a pair of drive members symmetrically spaced from a longitudinal center line of the belt, and the drive members engaging an outer surface of the carrier belt.

7. A belt conveyor system comprising:
a frame having a first side and a second side and an opening extending there between;
a drive sprocket substantially located on the first side of the frame, with a portion of the drive sprocket projecting through the opening to the second side of the frame;
a belt plate located on the second side of the frame; and
a looping belt movably entrained about the belt plate and selectively engaging the portion of the drive sprocket projecting through the opening.

8. The belt conveyor system as set forth in claim 7 further including first and second posts projecting outwardly from the second side of the frame and adapted to support the belt plate and looping belt in a spaced relation with the frame and drive sprocket.

9. The belt conveyor system as set forth in claim 8 further including:
a first retaining pin for threadably coupling the belt plate with the first post; and
a second retaining pin for slidably coupling the belt plate with the second post,
wherein removing the first retaining pin allows for slidably disassociating the belt plate and looping belt from the frame and drive sprocket.

10. The belt conveyor as set forth in claim 7 further including a tensioner associated with the belt plate and adapted to allow for tensioning the looping belt upon the belt plate.

11. The conveyor belt system according to claim 1 wherein the drive sprocket comprises a plurality of tooth selectively engaging teeth receivers formed in the belt.

12. The conveyor belt system according to claim 1 wherein the belt includes a friction engagement strip for selective engagement with the sprocket.

13. The conveyor belt system according to claim 1 further comprising a tensioner operable to adjust the tension in the belt, and the tensioner displacing the belt to a point below the level of the drive sprocket.

14. The conveyor belt system according to claim 13 wherein the belt rises to engage the sprocket at an angle of approximately 3°.

15. A method of changing a conveyor belt supported by a frame, the method comprising:
stopping a drive motor, and
disengaging a belt from an exterior drive mechanism.

16. The method according to claim 15 further comprising, removing a belt plate from the frame, the belt being supported by the belt plate.

17. The conveyor belt system according to claim 16 further comprising, removing the belt from the belt plate.

18. The conveyor belt system according to claim 15 wherein disengaging the belt comprises pivoting the belt, and a belt plate on which it is mounted, away from the drive mechanism.

19. The conveyor belt system according to claim 15 wherein disengaging the belt comprises removing securement pins from the frame.

20. A belt conveyor system comprising:
a frame having a first side and a second side and an opening extending there between;
a drive sprocket substantially located on the first side of the frame, with a portion of the drive sprocket projecting through the opening to the second side of the frame;
a belt plate located on the second side of the frame;
first and second posts projecting from the second side of the frame and adapted to support the belt plate in a spaced relation with the second side of the frame and the drive sprocket;
a first retaining pin for threadably coupling the belt plate with the first post;
a second retaining pin for slidably coupling the belt plate with the second post, wherein removing the first retaining pin allows for slidably disassociating the belt plate from the frame and drive sprocket;
a looping belt movably entrained about the belt plate and adapted to engage the portion of the drive sprocket projecting through the opening; and
a tensioner associated with the belt plate and adapted to allow for tensioning the looping belt upon the belt plate.
